(19) United States
(12) Patent Application Publication
(10) Pub. No.: US 2001/0036994 A1
(43) Pub. Date: Nov. 1, 2001

(54) Carbon black

(76) Inventors: Klaus Bergemann, Kerpen-Sindorf (DE); Egon Fanghanel, Halle/S. (DE); Thomas Luthge, Leuna (DE); Karl Vogel, Alzenau-Michelbach (DE)

Correspondence Address: PILLSBURY WINTHROP LLP, 1600 TYSONS BOULEVARD, MCLEAN, VA, 22102, US

(21) Appl. No.: 09/809,028

(22) Filed: Mar. 16, 2001

(30) Foreign Application Priority Data
Mar. 16, 2000 (DE) 100 12 784.3

(51) Int. Cl. C08K 3/04; C08K 5/36; C01D 3/00

(52) U.S. Cl. 524/495; 524/392; 423/449.2

(57) ABSTRACT

A carbon black with organic groups in which the organic groups are linked to the black via a sulfide- and/or polysulfide bridge. Furthermore, a method of producing the black of the invention is described in which carbon black and compounds of the general formula R—S_{y}—R are reacted. The carbon blacks of the invention can be used as filler, UV stabilizer, conductivity black and pigment.

This application claims priority from German Application DE 100 12 784.3, filed on Mar. 16, 2000, the subject matter of which is hereby incorporated herein by reference.

### BACKGROUND OF THE INVENTION

1. Field of the Invention

The invention relates to a carbon black, a method of its production and a method of use.

2. Background Information

It is known that carbon black (“black”) can be provided with organic groups that are linked to the carbon black by a diazonium group produced via the primary amine (WO 96/18688).

This known method has the following disadvantages:

The modification by means of diazonium salts takes place primarily in aqueous phase. Due to the high evaporation enthalpy of water, the subsequent necessary drying step is associated with a high expenditure of energy, and substantial expense.

In addition to the actual modification reagent, the pH must be adjusted, predominantly by the addition of acids. These acids are not bound to the carbon black but constitute impurities in the carbon black unless they are removed by purification steps.

The use of nitrite in an acidic medium is required to carry out the diazotization. Poisonous nitrogen oxides can develop as a result.

The non-ionic, organic nitrites that can also be used for diazotization are somewhat poisonous and readily combustible. Groups of the nitrites (counterions, alkyl groups) remain unbound as contaminant in the carbon black.

Modified carbon blacks are known from “Kautschuk Gummi Kunststoffe” 10, 681-687 (1999) that are obtained by the radical reaction of fatty acids with black using DCP as radical former.

Furthermore, carbon blacks with chemically bound functional groups are known that are produced by groups that form radicals such as

Peroxidic polymers (JP 11335603),

Polymers containing azo groups (JP 11335602),

A1—O—O—A2 with A1, A2=hydrocarbyl, aryl, heterocyclene (JP 11335587),

A1—OCOO—A2 (JP 11335586),

Diacylperoxide (JP 11335601)

Oxidation with peroxydicarbonate derivatives (JP 11323179),

Azonitrile compounds (JP 11323176),

Azo compounds (JP 11323229),

Hydroperoxides (JP 11323222),

Tetraoxacyclohexane (JP 11323180),

Compounds of hyponitrous acid (JP 11323178) and

Azide compounds (JP 11323177).

EP 0 569 503 teaches a method for the surface modification of carbon-containing material with aromatic groups by electrochemical reduction of a diazonium salt.

Disadvantages of the azide, azo and peroxide compounds are their low stability in storage, ready decomposition and the associated difficult handling.

### SUMMARY OF THE INVENTION

It is therefore an object of the invention to provide a carbon black with organic groups which is not contaminated by acids, salts and similar compounds, and that does not have to be dried with a high expenditure of energy, wherein no poisonous waste gases are produced during the modification, no or only slight amounts of readily removable solvents are required, wherein modification is possible without solvents and the modification agent is stable in storage and can be readily handled.

In one embodiment, the invention provides a carbon black with organic groups that are connected to the carbon black by at least one sulfide- and/or polysulfide bridge.

The carbon black with organic groups can have the formula black-Sₓ—R in which

R=alkyl, alkyl functionalized by Y, polymers, cyclic organic groups, aryl, aryl ArYₙ with n=1-5 functionalized by Y,

Y=—OH, —SH, —SO₃H, —SO₃M, —B(OH)₂, —O(CH₂—CH₂—O)ₙ—H, —COOH, —COOM, —NH₂, —NR₂, —N((CH₂—CH₂—O)ₙH)₂, CON((CH₂—CH₂—O)ₙH)₂, trialkoxysilyl, perfluoroalkyl, R², —NH₃⁺, —NR²₃⁺, —SO₂—NR²₂, —NO₂, —Cl, —CO—NR²₂, —SS—, —SCN with

R²=aliphatic group, e.g., alkanes, alkenes, alcohols, ethers, aldehydes, ketones, carboxylic acids or hydrocarbons, a cyclic organic group, e.g., alicyclic hydrocarbons, an organic compound with an aliphatic and a cyclic part that is substituted or unsubstituted, branched or unbranched, chromophoric groups or dyes and

X=1-8, preferably 1.

Cyclic organic groups can be cycloalkyls, cycloalkenyls, heterocyclic compounds such as, e.g. pyrrolidinyl-, pyrrolinyl-, piperidinyl or morpholinyl, aryl groups such as, e.g., phenyl, naphthyl or anthracenyl, as well as heteroaryl groups such as, e.g., imidazolyl, pyrazolyl, pyridinyl, thienyl, thiazolyl, furyl or indolyl.

In a preferred embodiment the organic group contains no silicon.

The carbon black used as the starting material can be furnace black, gas black, channel black, flame black, thermal black, acetylene black, plasma black, inversion blacks, known from DE 195 21 565, Si-containing blacks known from WO 98/45361 or DE 19613796, or metal-containing blacks known from WO 98/42778, arc blacks and blacks that are the byproducts of chemical production processes. The black can be activated by established reactions.

Blacks can be employed that are used as reinforcement filler and rubber mixtures. Colored blacks can also be used. Other possible blacks are: Conductivity black, black for UV stabilization, black as filler in other systems than rubber such as, e.g., in bitumen, plastic, black as reducing agent in metallurgy.

In another embodiment, the invention provides a carbon black with organic groups that is characterized in that it can be obtained by reacting organic compounds of the general formula R—S_{y}—R with y=2-10 with carbon black.

The initially applied groups can also be further modified by subsequent reactions.

In yet another embodiment, the invention provides a method of producing the carbon black in accordance with the invention which method is characterized in that black is reacted with compounds of the general formula R—S_{y}—R in which y=2-10, R has the meaning cited above and R can be the same or different. The R groups can be tailored to suit the potential areas of application since the reaction principle discovered permits the introduction of hydrophilic as well as lipophilic groups. The groups can also be ionic[ly], polymeric[ally reactive] or reactive for further reactions.

Compounds comprising bonds that can be radically split can be used as compounds of the general formula R—S_{y}—R.

In a preferred embodiment the organic group R contains no silicon.

The compound of formula R—S_{y}—R can be applied on the carbon black by being mixed in or sprayed on. The compound of formula R—S_{y}—R can be applied as powder, melt or solution. It is especially advantageous if the compound is applied during the production of the carbon black, during which the addition of the organic compound takes place at a location exhibiting the necessary temperature.

The reaction for modifying the carbon black can be carried out without solvent or in a solvent, preferably a slightly volatile, organic solvent.

The reaction for modifying the carbon black can be carried out by tempering.

The reaction for modifying the carbon black can be carried out at temperatures from 0° C.-300° C., preferably 150° C.-250° C.

The carbon blacks in accordance with the invention and with organic groups can be used as filler, reinforcing filler, UV stabilizer, conductivity black as well as pigment in rubber, plastic, printing inks, inks, inkjet inks, paints and dyes, bitumen, concrete, other construction materials and paper. They can also be used as reducing agent in metallurgy. Means for using carbon blacks in these ways are familiar to those of skill in the art.

The carbon blacks in accordance with the invention have the advantage that

Carbon blacks modified in a polar manner (e.g., with —SO₃— groups) can be better dispersed in polar systems, with precedence water,

Carbon blacks modified in a non-polar manner (e.g., with alkyl groups) can be better dispersed in non-polar systems such as, e.g., oils,

Suitably modified carbon blacks with polar or sterically bulky groups are stabilized electrostatically or sterically in the systems,

Modified carbon blacks are better-stabilized in dispersions and exhibit better coloristic qualities such as color depth and blue cast,

Carbon blacks with substituents that continue to be reactive can be used for coupling and cross-linking in systems (e.g., rubber),

Reactively modified carbon blacks make it possible to bind the carbon black to the polymer.

Advantages of the method of the invention are the good stability in storage of the initial compounds and the fact that they can be readily handled. Carbon blacks in accordance with the invention can be produced that are low in byproducts, salts, acids and moisture.

### DETAILED DESCRIPTION OF THE INVENTION

### EXAMPLE

20 g of the disulfide according to formula I

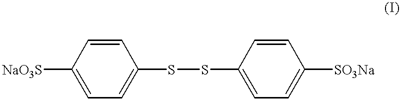

is applied in a finely distributed manner as aqueous solution onto 100 g color black FW 1 and the solvent removed. The following solid-state reaction is carried out five hours at 180° C. and 250° C. oven temperature. The yield is 90% (at 180° C.) and 95% (at 250° C.).

Color black FW 1 is a commercial product of Degussa AG.

What is claimed is:

1. A carbon black having organic groups that are linked to the carbon black via at least one sulfide- and/or polysulfide bridge.

2. The carbon black with organic groups according to claim 1 having the formula R—Sₓ—R in which
R=alkyl, alkyl functionalized by Y, polymers, cyclic organic groups, aryl, aryl ArYₙ with n=1-5 functionalized by Y,
Y=—OH, —SH, —SO₃H, —SO₃M, —B(OH)₂, —O(CH₂—CH₂—O)ₙ—H, —COOH, —COOM, —NH₂, —NR₂, —N((CH₂—CH₂—O)ₙH)₂, CON((CH₂—CH₂—O)ₙH)₂, trialkoxysilyl, perfluoroalkyl, R², —NH₃⁺, —NR²₃⁺, —SO₂—NR²₂, —NO₂, —Cl, —CO—NR²₂, —SS—, —SCN with
R²=aliphatic group, a cyclic organic group, an organic compound with an aliphatic and a cyclic part that is substituted or unsubstituted, branched or unbranched, chromophoric groups or dyes and
X=1-8.

3. A carbon black with organic groups that is obtained by reacting organic compounds with the general formula R—S_{y}—R in which y=2-10 and R has the meaning cited above.

4. A method of producing the carbon black of claim 1, comprising the step of reacting a carbon black and a compound of formula R—S_{y}—R in which y=2-10 and R has the meaning cited above wherein the two R groups are identical or different.

5. The method according to claim 4, wherein the reaction is carried out in a solvent.

6. The method according to claim 4, wherein the reaction is carried out without solvent.

7. A filler, reinforcing filler, conductivity black, pigment and UV stabilizer in rubber, ink, dye, inkjet ink, printing ink, paint, concrete, plastic, construction material, paper or bitumen comprising a carbon black according to one of claims 1-3.
